(19) United States
(12) Patent Application Publication
(10) Pub. No.: US 2022/0233020 A1
(43) Pub. Date: Jul. 28, 2022

(54) SOUS VIDE COOKING CONTROL METHOD

(71) Applicant: June Life, Inc., San Francisco, CA (US)

(72) Inventors: Nikhil Bhogal, San Francisco, CA (US); Wiley Wang, San Francisco, CA (US); Jithendra Paruchuri, San Francisco, CA (US)

(21) Appl. No.: 17/582,422

(22) Filed: Jan. 24, 2022

Related U.S. Application Data
(60) Provisional application No. 63/140,673, filed on Jan. 22, 2021.

(51) Int. Cl. A47J 36/32; A47J 27/10; A23L 5/10; G05D 23/19; G05B 17/02

(52) U.S. Cl. CPC A47J 36/32; A47J 27/10; A23L 5/13; A23V 2002/00; G05B 17/02; A47J 2202/00; G05D 23/1951

(57) ABSTRACT

In variants, the method for in-appliance sous vide cooking control can include: determining a thermal model, determining an equilibrium temperature based on the thermal model, facilitating control of a cooking appliance based on the equilibrium temperature, and/or other processes.

### CROSS REFERENCE TO RELATED APPLICATIONS

This application claims the benefit of U.S. Provisional Application No. 63/140,673, filed 22 Jan. 2021, which is incorporated herein in its entirety by this reference.

### TECHNICAL FIELD

This invention relates generally to the cooking appliances field, and more specifically to a new and useful sous vide control system and/or method in the cooking appliances field.

### BRIEF DESCRIPTION OF THE FIGURES

FIG. 1 is a schematic representation of the method.

FIG. 2 is a diagrammatic representation of a variant of the method.

FIG. 3 is a diagrammatic representation of a variant of the method.

FIG. 4A is a diagrammatic representation of an example of the method.

FIG. 4B is a diagrammatic representation of an example of the method.

FIG. 5 is a schematic representation of a variant of the system.

FIG. 6 is a diagrammatic representation of a variant of the method.

FIGS. 7A and 7B are illustrative examples of variants of the system.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview.

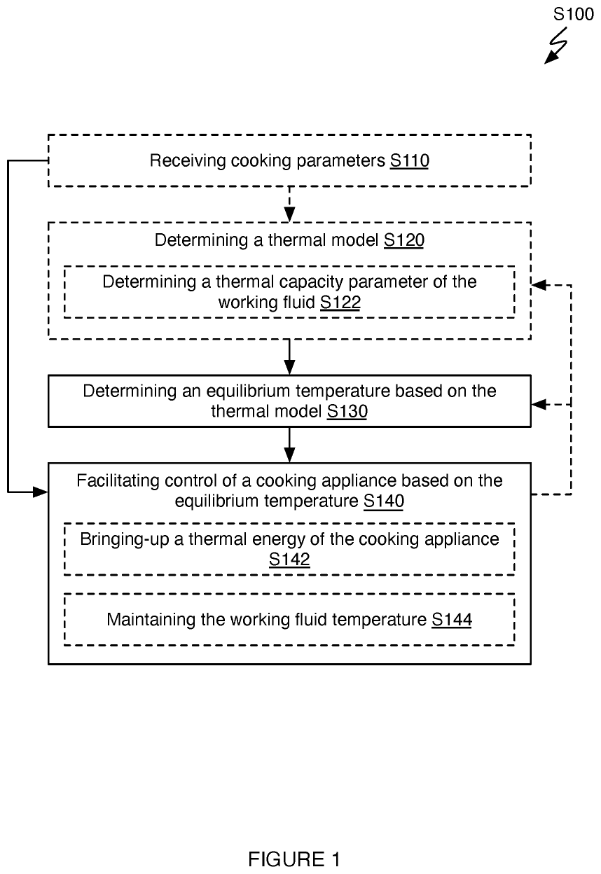

The method S100, an example of which is shown in FIG. 1, can include: determining a thermal model S120, determining an equilibrium temperature based on the thermal model S130, and facilitating control of a cooking appliance based on the equilibrium temperature S140. The method S100 can optionally include receiving cooking parameters S110. However, the method S100 can additionally or alternatively include any other suitable elements. The method S100 functions to enable sous vide cooking by controlling the temperature of the working fluid within a vessel using the cooking appliance.

This technology can leverage the systems and/or methods disclosed in U.S. application Ser. No. 15/147,597, filed 5 May 2016, which is incorporated herein in its entirety by this reference.

This technology can leverage the systems and/or methods disclosed in U.S. application Ser. No. 17/124,264, filed 16 Dec. 2020, and U.S. application Ser. No. 17/245,778 filed 30 Apr. 2021, each of which are incorporated herein in its entirety by this reference.

### 1.1 Illustrative Examples

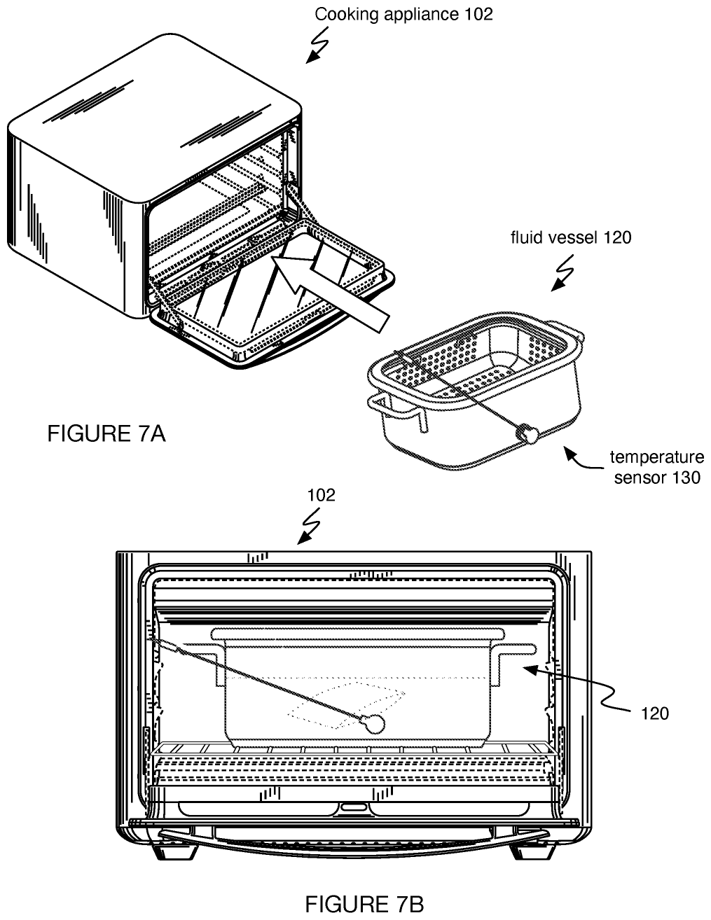

In a first set of variations, a system for sous vide cooking can include: a cooking appliance, which includes: a cooking cavity, a set of heating elements within the cooking cavity, and a cooking cavity temperature sensor thermally coupled to the cooking cavity and fluidly coupled to interior air within the cooking cavity; a vessel containing a working fluid (e.g., working liquid, liquid water) and arranged within the cooking cavity, wherein the vessel is at least partially surrounded by the interior air; a temperature probe thermally coupled to the working fluid; a processing system communicatively coupled to the temperature probe, the appliance temperature sensor, and the set of heating elements; and/or a non-transitory computer readable medium having stored thereon software instructions that, when executed by the processing system, cause the processing system to pre-heat the cooking appliance for sous vide cooking at a target temperature by: controlling the set of heating elements to heat the cooking cavity; determining (e.g., selecting) a thermal model based on a series of temperature measurements received from the temperature probe; estimating an equilibrium temperature for the vessel using the thermal model, based on a first temperature received from the temperature probe and a second temperature received from the appliance temperature sensor; and in response to the equilibrium temperature satisfying a target condition based on the target food temperature, ceasing heating with the set of heating elements; wherein the first temperature is below the target temperature when heating is ceased and/or the equilibrium temperature is below the target temperature (e.g., by a predetermined difference) when heating is ceased. In variants, the target condition can be a temperature range which is asymmetric about the target food temperature. In variants, after pre-heating the thermal system, the processing system can be further configured to: determine that working fluid has reached the target temperature using the temperature probe; and, subsequently, control the set of heating elements to maintain the working fluid at the target foodstuff temperature using temperature feedback from the temperature probe. In variants, the temperature probe can be thermally coupled to the working fluid through a thickness of a vessel wall. In variants, the vessel can be surrounded by the interior air on at least two sides (e.g., as an example, vessel can removably arranged within the cooking appliance, such as on a rack of the cooking appliance; examples are shown in FIG. 7A and FIG. 7B). In variants, processing system is further configured to repeat the pre-heating of the cooking appliance in response to the first temperature falling below a temperature threshold.

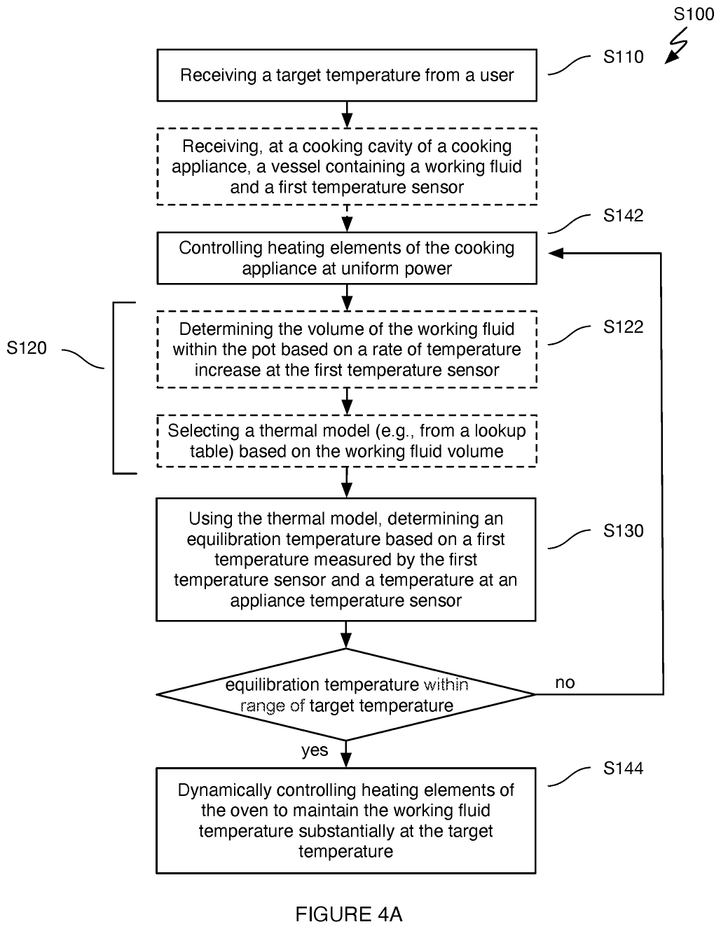

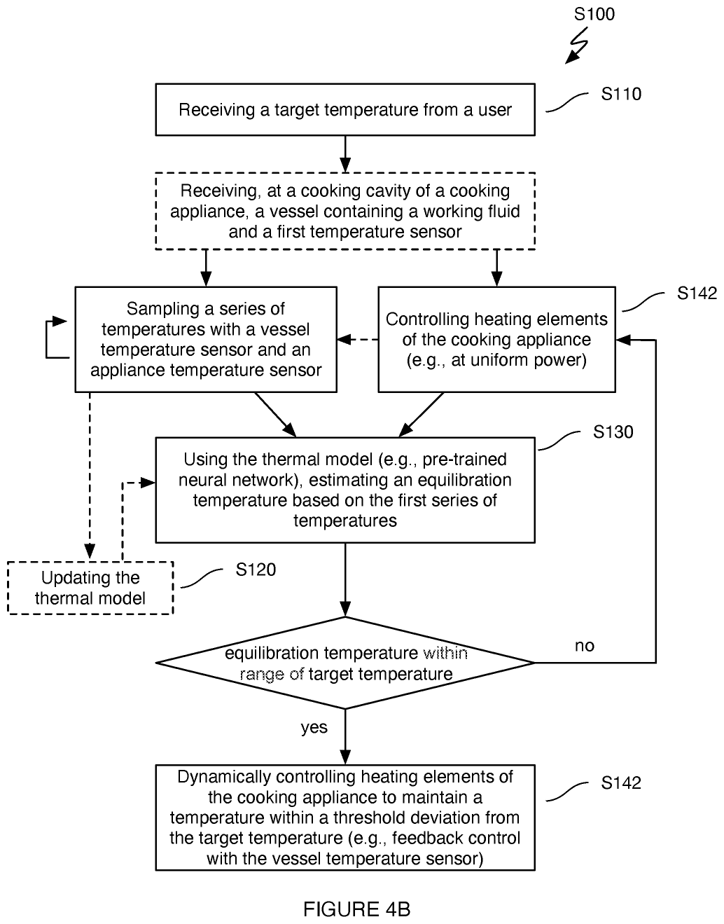

In a second set of variations, a method for sous vide cooking within a cooking cavity of a cooking appliance, can include: determining a target foodstuff temperature; heating a thermal system including the cooking cavity, a working fluid, and a vessel within the cooking cavity which contains the working fluid, which includes: controlling a set of heating elements to heat the cooking cavity; receiving a series of temperature measurements from a first temperature sensor thermally coupled to the working fluid; based on the series of temperature measurements and using a thermal model for the thermal system, estimating an equilibrium temperature of the thermal system based on a first measurement from the first temperature sensor and an appliance temperature; and in response to the equilibrium temperature satisfying a target condition based on the target foodstuff temperature, ceasing heating with the set of heating elements; and subsequently, when an equilibration condition is satisfied, controlling the heating elements to substantially maintain the working fluid at the target foodstuff temperature using temperature feedback from the first temperature sensor. In variants, the method can further include: while heating the thermal system prior to satisfaction of the target condition, determining the thermal model based on the series of temperature measurements. As a first example, determining the thermal model can include estimating thermal capacity of the thermal system based on a rate of change of the series of temperature measurements. As a second example, the thermal model can be determined using a trained neural network (e.g., an example is shown in FIG. 4B). In variants, the thermal model can be a neural network model.

### 2. Benefits.

Variations of the technology can afford several benefits and/or advantages.

First, variations of this technology can enable sous vide cooking within a cooking appliance and/or cooking using an unsubmerged heat element (e.g., indirect heating; heating through a secondary working fluid such as interior air within the appliance). Accordingly, such variants can eliminate the need for dedicated ‘sous vide’ appliances or instruments by enabling multifunction operation of a connected appliance. In a specific example, the technology can facilitate sous vide cooking within a convection oven or smart oven.

Second, variations of this technology can minimize a time to reach an equilibrated target temperature of a working fluid for sous vide cooking processes. Such variants can model the thermal redistribution within a cooking appliance cavity based on a temperature difference between the working fluid and the cooking cavity, and rapidly apply heat to minimize the time needed to achieve the appropriate temperature difference.

Third, variations of this technology can avoid overshoot in the working fluid temperature for sous vide cooking processes. Overshoot may be particularly difficult to alleviate in indirect heating thermal systems that employ working fluids with high heat capacity (e.g., water), since heat can be added more readily than it can be rejected (e.g., which may be especially true for highly insulated appliances, such as ovens, without intervention from a user). Concurrent heating of working fluid and the remainder of the cooking cavity (e.g., metal walls, air, etc.) can result in significant overshoot for appliance control schemes based solely on feedback of the working fluid temperature, since heat exchanged between the working fluid and its surroundings (which are oftentimes hotter than the working fluid during ramp up) can result in temperature rise after heat element operation has ceased (e.g., where the surroundings have lower specific heat than the working fluid, and therefore uniform heating can lead to a large temperature difference between the working fluid and interior cavity of the appliance). Accordingly, overshooting a target temperature during sous vide can result in adverse cooking affects—such as cooking temperature gradients in meat (e.g., which may be visible as a gradient in the ultimate ‘doneness’) and/or overshooting the internal temperature. Some variants of the method can dynamically control the temperature of the working fluid to (rise to and) remain within a threshold deviation from a target temperature by iteratively/repeatedly estimating the working fluid's (future) equilibrium temperature using a thermal model, which can account for the temporal effects of appliance heating.

However, variations of the technology can additionally or alternately provide any other suitable benefits and/or advantages.

### 3. System.

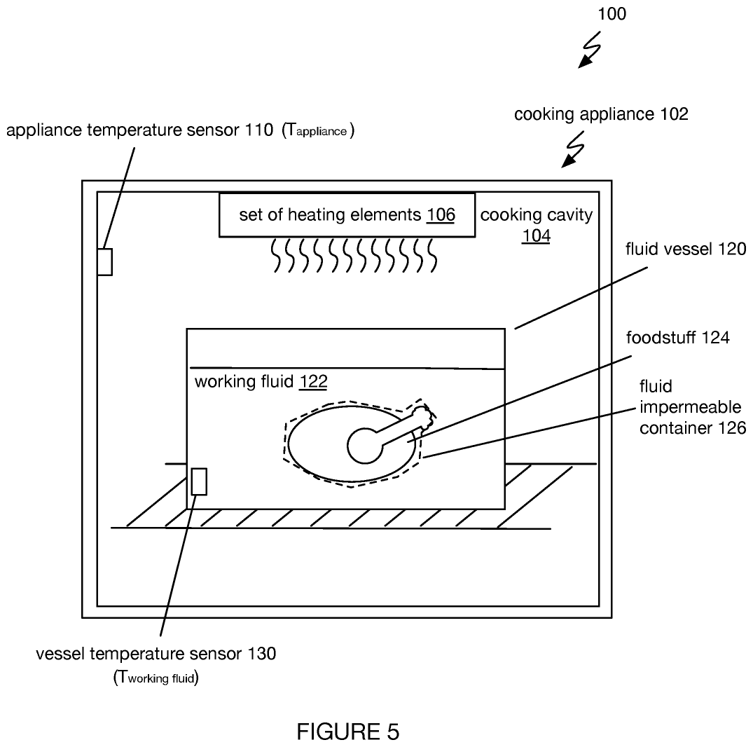

The method can be used in conjunction with a system 100, an example of which is shown in FIG. 5, which can include a cooking appliance 102, an appliance temperature sensor 110, a fluid vessel 120, and a vessel temperature sensor 130. However, the system can include any other suitable elements. The fluid vessel 120 can house a working fluid 122, foodstuff 124, and a fluid impermeable container. The vessel temperature sensor 130 can be integrated into the vessel and/or can be removable coupled to the vessel and/or working fluid. Likewise, the appliance temperature sensor no can be integrated into the appliance, removably connected, and/or otherwise configured. The system functions to facilitate sous vide cooking by controlling the temperature of the working fluid within a vessel using the cooking appliance in accordance with method S100.

The method S100 can be employed in conjunction with a cooking appliance 102, which functions to facilitate sous vide cooking in accordance with the method. Preferably, the cooking appliance is an oven, but can alternatively be any appliance with a heated cooking cavity (e.g., convection oven, microwave oven, grill, etc.), or other suitable appliance. The appliance is preferably a digitally controllable appliance, but can additionally be manually and/or wirelessly controllable. The cooking appliance can enable wired and/or wireless communication with the vessel temperature sensor 130. The appliance can include: an electrical jack in the appliance interior which connects via a wire/cable to the temperature sensor, an electrical jack located on the exterior of the appliance, a wireless connection (e.g., via Bluetooth, WiFi, etc.), and/or any other suitable interface with the vessel temperature sensor, fluid vessel, or other system. Alternatively, the vessel temperature sensor 130 can be remotely connected to a processing system executing any suitable portions of the method S100. Preferably, the cooking appliance includes a processing module to execute S100, however some or all processing/control can be performed on a connected device (e.g., such as an external controller, user device, cell phone, tablet, etc.), and/or otherwise executed.

In variants, the connected appliance can be a connected oven and/or cooking system as described in U.S. application Ser. No. 15/147,597, filed 5 May 2016, which is incorporated in its entirety by this reference. Additionally or alternatively, the connected appliance can be employed with the cooking system and/or cooking method as described in U.S. application Ser. No. 17/126,973, filed 18 Dec. 2020, which is incorporated in its entirety by this reference. Additionally or alternatively, the connected appliance can be employed with the cooking system and/or method as described in U.S. application Ser. No. 17/124,264, filed 16 Dec. 2020, which is incorporated herein in its entirety by this reference.

The cooking appliance 102, an example of which is shown in FIG. 5, preferably defines a cooking cavity 104 and includes a temperature sensor 110 (e.g., mounted to the cooking cavity and/or thermally connected to interior air within the cooking cavity; integrated within the appliance) and a set of heating elements 106. The appliance 102 can optionally include convection elements, which function to circulate air within the cooking cavity. The appliance temperature sensor 110 functions to measure the temperature of the cooking cavity (e.g., or a specific wall thereof).

The set of heating elements functions to heat the cooking cavity and a working fluid therein to modify the temperature. The heating elements are preferably resistive heating elements, but can alternatively be inductive heating elements, gas burners, and/or other suitable heating elements. Most preferably, the heating elements are constructed of carbon fiber or quartz, but they can additionally or alternatively be manufactured from any suitable metal, metal alloy, ceramic, and/or other material. The heating elements can be located on the top, bottom, broad faces (front and/or back), narrow face(s), and/or other suitably located within the interior/exterior of the appliance. The heating elements can be individually controllable, controlled in banks, controlled as a unitary population, or otherwise controlled. In examples, the heating elements can be individually controlled to create an uneven, even, or other temperature profile within the cooking cavity. The heating elements can be controlled variably (e.g., at different power outputs and/or heating levels) or a single power output (e.g., binary on/off control). The heating elements are preferably unsubmerged heating elements which are separated and/or offset from liquid working fluid within the cooking appliance (e.g., working fluid 122 within the vessel 120). As an example, the heating elements can conductively heat the cooking cavity 104 and/or the walls of the cooking cavity; convectively (e.g., natural/free convection; forced convection) heat interior air contained within the cooking appliance; and/or otherwise heat objects within the cooking cavity 104. However, the appliance can include any other suitable heating elements.

The cooking appliance can optionally include one or more: convection elements (e.g., fans) to move air and/or other working fluids within the interior cavity, racks to support one or more cooking vessels in the interior of the appliance, optical sensors (e.g., camera) to detect the presence of the vessel (and/or the lid, tray, foodstuff within the vessel, working fluid level, etc.), and/or any other suitable components. The optical sensor can be located: inside the cavity (e.g., along the top, bottom, left, right, back, front, door, corners, thresholds, and/or other location), on the top surface of the interior of the appliance cavity, optically connected to the appliance cavity, be separate from the cooking appliance (e.g., be the optical sensor of a mobile device, such as a smartphone), and/or otherwise suitably implemented.

The cooking cavity of the appliance can receive and/or retain a fluid vessel 120 which can contain a working fluid (e.g., water, broth, other solutions, etc.). A vessel temperature sensor 130 is thermally and/or fluidly connected to the working fluid within the fluid vessel—such as by direct insertion into the liquid and/or by the system as described in Ser. No. 17/124,264, filed 16 Dec. 2020, which is incorporated herein in its entirety by this reference. The vessel temperature sensor and the appliance temperature sensor are each communicatively connected to a processing system, which can be integrated into the appliance and/or remote, and used for appliance control by the method S100.

However, any other suitable cooking appliance can be used, or the cooking appliance can be otherwise configured.

The fluid vessel is preferably removably arranged within the cooking appliance during sous vide cooking and/or during all or a portion of the method S100 (e.g., during S144). The fluid vessel is preferably surrounded by air within an interior of the cooking cavity on at least two sides (e.g., a cylindrical outer wall, upper surface) and/or all sides (e.g., when arranged on an oven rack, for example), which may insulate the fluid vessel and/or reduce heat loss to the surrounding environment (e.g., the thermal resistance introduced by an air gap may provide an advantageous insulating effect while maintaining a target temperature for sous vide cooking).

However, the fluid vessel can be otherwise configured and/or any other suitable fluid vessel can be used.

However, the system can include any other suitable elements.

### 4. Method.

The method S100, an example of which is shown in FIG. 1, can include: determining a thermal model S120, determining an equilibrium temperature based on the thermal model S130, and facilitating control of a cooking appliance based on the equilibrium temperature S140. The method S100 can optionally include receiving cooking parameters S110. However, the method S100 can additionally or alternatively include any other suitable elements. The method S100 functions to enable sous vide cooking by controlling the temperature of the working fluid within a vessel using a cooking appliance.

Optionally receiving cooking parameters S110 functions to establish model inputs (and/or targets) to determine appliance control. Cooking parameters can be received from a user and/or user specified, but can additionally or alternatively be received from user a database (e.g., remote database, local memory onboard the cooking appliance or a mobile device, etc.), received in conjunction with a predetermined recipe, or otherwise determined. Cooking parameters preferably include a target temperature for foodstuff or working fluid (e.g., internal temperature of meat, etc.), but can additionally include: a foodstuff amount (e.g., volume, weight, etc.), foodstuff class (e.g., meat, vegetables, chicken, beef, etc.), foodstuff state (e.g., frozen, refrigerated, room temperature, etc.), an ambient temperature (e.g., room temperature), working fluid type (e.g., water, oil, etc.), working fluid volume, vessel classification (e.g., size of vessel—such as where the vessel includes a specific sous vide fill line/indicator), cooking duration, and/or any other suitable cooking parameters. In variants cooking parameters, can additionally include a preheating configuration. In a specific example, the foodstuff can be arranged within the cooking cavity (submerged within the working fluid, such as while enclosed by a fluid impermeable container such as a vacuum sealed bag) during preheating. In a second example, the foodstuff can be inserted into the cooking cavity after preheating (e.g., after temperature is equilibrated, after heat application to the working fluid, at a specific time interval, etc.).

However, cooking parameters can be otherwise suitably determined and/or received.

Determining a thermal model S120 functions to determine a model which can be used to enable estimation of an equilibrium temperature to facilitate appliance control (e.g., in accordance with S140). The equilibrium temperature can be: the ‘intersection’ temperature between the working fluid and cooking cavity temperature curves with no heat addition to the thermal system (e.g., heat element operation has ceased; heat element heating is substantially balanced with heat loss to the surroundings; etc.); the maximal (estimated) temperature of the working fluid with no heat addition to the thermal system; the temperature that the working fluid stabilizes to, assuming immediate heating cessation; and/or otherwise defined.

S120 can include: generating a thermal model (e.g., training a thermal model), updating a thermal model, selecting a thermal model (e.g., selecting a predetermined thermal model), calculating a thermal model (e.g., using regression, based on the instantaneous cooking session's measurements; etc.), and/or otherwise determining a thermal model. In a first example, the thermal model is generated based on one or more historical cooking session measurements. In a second example, the thermal model is generated or selected based on the current cooking session's measurements. S120 can be performed by the cooking appliance, a remote system (e.g., cloud platform), a user device, a distributed system, and/or any other system.

S120 can be performed: once (e.g., per cooking session, per cooking appliance, etc.), repeatedly, iteratively (e.g., at a predetermined frequency), in response to satisfaction of an evaluation condition, performed when temperature measurements are sampled (e.g., during heating and/or bring-up in accordance with S142), or otherwise performed. S120 is preferably performed while the cooking cavity is being heated (by the heating elements; prior to target condition satisfaction), but can additionally or alternatively be performed when the heating elements are shut off (e.g., with heating is temporarily ceased during power cycling; during S146; etc.), prior to operation of the appliance and/or foodstuff insertion (e.g., such as pre-training a model, prior to S110 and/or S140), after operation of the appliance (e.g., using a set of historical sessions to train/update a model for subsequent use), and/or at any other suitable time. In a specific example, a thermal model can be updated (e.g., during S140 and/or after a cooking session) based on a thermal leakage estimated for the cooking appliance (e.g., which may be estimated based on heat required to maintain the temperature of the working fluid; which can be used to remove noise in the sampled temperature)

S120 is preferably performed using working fluid and/or cavity temperature measurements, which can be sampled by the working fluid and/or cavity thermometers, respectively. S120 is preferably performed using the latest temperature measurements (e.g., performed in real-time and/or during runtime), but can be performed using prior temperature measurements (e.g., a series of historical measurements during a cooking session, etc.). S120 can be performed locally (e.g., at a local processing system onboard the cooking appliance, at a user device, etc.), remotely (e.g., remote processor; cloud processing, etc.), and/or ant any other suitable processing endpoints.

The thermal model inputs are preferably an individual cooking cavity temperature value and an individual working fluid temperature value. Additionally or alternatively, the thermal model can accept a single input of the temperature difference (temperature delta) between the working fluid temperature and the cooking cavity temperature into an expected temperature rise of the working fluid (where thermal properties are assumed to be substantially constant across the range of expected temperatures). Additionally or alternatively, the thermal model inputs can include: a change in the working fluid temperature (e.g., rate of change, acceleration, etc.), a change in the cavity temperature over time, the working fluid volume, the working fluid thermal capacity, the container volume, the mass of other objects (e.g., food) within the cook cavity, the thermal mass of other objects in the cook cavity, a series (e.g., time-series) of temperature measurements (e.g., as determined with the appliance temperature sensor and/or a vessel temperature sensor, retrieved from memory storage, etc.), cooking parameters, appliance parameters (e.g., historical heat-leakage parameter), sensor parameters (e.g., calibration offset, measurement noise parameters, etc.), heating element control instructions (e.g., power supplied to and/or emitted by the heating elements, etc.) and/or any other suitable variables. The thermal model preferably outputs an equilibrium temperature (e.g., a single value), but can additionally or alternatively output an equilibration duration, equilibrium duration, and/or other outputs. Optionally, the thermal model can further output estimated temperatures of a working fluid (e.g., as a function of time, as a time series, etc.).

The thermal model and/or parameters therein (e.g., constants, weights, power, etc.) can be selected from a set of pre-generated thermal models, dynamically calculated or estimated, and/or otherwise determined. The thermal model can be selected based on: parameters of the working fluid and/or cavity, such as the current temperature, starting temperature, and temperature rate of change; temperature difference between the working fluid and the cavity; elapsed time; working fluid volume; working fluid type; target temperature; difference between the target temperature and an initial working fluid temperature; heating element power output; cooking cavity type; and/or other selection parameters.

The thermal model can include one or more of: a regression model (e.g., a linear model, a nonlinear model, a curve, etc.), a machine learning (ML) model, neural network model (e.g., fully convolutional network [FCN], convolutional neural network [CNN], recurrent neural network [RNN], artificial neural network [ANN], etc.), a cascade of neural networks, an ensemble of neural networks, compositional networks, Bayesian network, Markov chains, clustering model, and/or any other suitable model(s).

In a first variant, the thermal model is a regression model (e.g., polynomial regression), more preferably a piecewise polynomial model, but can alternatively be any other suitable model. The system can include one or more piecewise polynomial models; alternatively, each polynomial piece can be considered an independent thermal model. The model parameters for each polynomial piece are preferably stored in a lookup table, but can be otherwise stored. Each polynomial piece is preferably associated with a (measured) working fluid temperature and cavity temperature pair, but can additionally or alternatively be associated with: a target temperature (e.g., wherein the model is selected based on the target temperature), working fluid volume, working fluid thermal capacity, a difference (temperature delta) between the working fluid temperature and the cavity temperature, and/or other selection parameters.

In a first example of the first variant, the model is selected (e.g., from a model lookup table) based on the measured working fluid temperature and the measured cavity temperature. In a second example, the axes of the lookup table can be: working fluid temperature, cooking cavity temperature, and a thermal capacity parameter (e.g., working fluid volume; index associated with the thermal capacity of the working fluid). In a third example, the axes of the lookup table can be: temperature difference (e.g., between the cooking cavity and working fluid temperature) and working fluid volume. Each cell of the lookup table preferably maps to equilibrium temperature, but can additionally or alternatively include a forward estimation of a temperature curve (e.g., working fluid temperature, cooking cavity temperature), a time to reach the equilibration temperature (e.g., duration of equilibration), and/or any other suitable parameters.

In a second variant, the thermal model can be a neural network (e.g., FCN; an example is shown in FIG. 4B). For example, neural network can be generated and/or updated using reinforcement learning (e.g., prior to an individual instance of S100 execution; updated during and/or after execution of an individual instance of method S100; an example is shown in FIG. 4B) based on the temperature measurements and/or temperature differences of historical sous vide cook sessions to estimate the equilibrium temperature of the thermal system. This thermal model can be subsequently used by the first variant, or otherwise used.

The thermal model is preferably empirically determined (e.g., using historical temperature measurements from the cooking appliance or a similar cooking appliance), but can additionally or alternatively be determined analytically and/or otherwise generated. In an example, an empirical thermal model can be generated by iteratively heating various volumes of working fluid and observing the temperature curves in the absence of additional heating, and/or observing the equilibration of pre-heated/pre-cooled fluids (at a various temperatures) in the appliance at pre-heated temperatures. The equilibrium temperatures can be taken as the apex of a smoothed temperature curve, averaged across multiple trials, and/or otherwise suitably determined. In a second example, a neural network can be trained and/or updated based on historical temperature measurements (e.g., series of measurements from a vessel temperature sensor and an appliance temperature sensor).

Determining the thermal model S120 can optionally include determining a thermal capacity parameter of the working fluid S122, which functions to establish a relationship between the thermal capacity of the working fluid and the thermal capacity of the walls of the cooking cavity. Additionally or alternatively, S122 can be used to relate the temperature of the working fluid and the temperature of the cooking cavity as a part of the determination of the thermal model. S122 can function to determine: a thermal capacity of the working fluid, the specific heat capacity of the working fluid (and/or thermal system including the vessel, working fluid and/or foodstuff therein), a ratio of the heat capacity of the working fluid and the heat capacity of the cooking cavity, a volume of the working fluid, and/or a model index. In variants where the thermal model includes neural network model, the thermal capacity parameter can be value of an input parameter (e.g., input feature; provided to an input layer as an observed variable of a neural network) or can be a value of a hidden variable (e.g., latent variable; within a hidden layer of a neural network).

The thermal capacity parameter can be determined once (e.g., after a predetermined duration, after a predetermined working fluid temperature rise; manual determination, optical determination, etc.), repeatedly, periodically, in response to a temperature (e.g., working fluid temperature, appliance temperature, temperature delta, etc.) exceeding a threshold, and/or with any other suitable timing. The thermal capacity parameter is preferably determined during bring-up (and/or pre-heating), but can be otherwise suitably determined.

In a first set of variants, S122 can function to determine a value (e.g., parameter value of a neural network; parameter of a regression model; etc.) and/or index (e.g., of a thermal model lookup table) associated with the working fluid volume (e.g., where the working fluid has a predetermined specific heat—as provided in Joules per deg Celsius per kilogram; etc.). In such variants, the working fluid volume can be determined manually (e.g., received in S110) and/or automatically. In a first example, the working fluid volume is prescribed and/or received before preheating as a cooking parameter from S110. In a second example, the working fluid volume is determined based on an optical classification of the vessel and/or an optical determination (e.g., water level at periphery of vessel cavity). In such cases, the optical sensor can be arranged on the top of the appliance and/or directed downwards towards the vessel, and the water volume can be determined based on a relative position of the water level on the side of the vessel—such as by comparing the water level to a graded scale and/or height relative to the lip of the vessel and the base (e.g., internal radius at base).

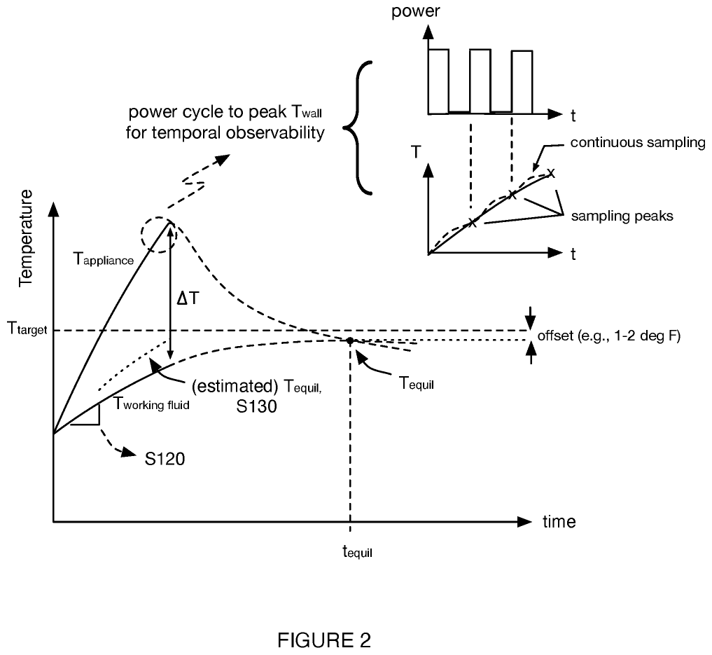

In a second set of variants, the thermal capacity parameter (e.g., working fluid volume, index for the thermal model) can be directly or implicitly determined based on a series of temperature measurements (e.g., sampled during S142), such as based on the slope (rate of change) of the temperature curve(s)—examples of which are shown in FIG. 2 and FIG. 4A. In variants, the slope of the working fluid temperature curve can be related to the working fluid volume and the heating power applied to the thermal system. Where the heat elements preheat the system with a substantially uniform (e.g., maximal, above a predetermined power threshold, etc.) input, this determination can be made using a lookup table, directly mapping the slope of the working fluid temperature curve to a value for the working fluid volume. Alternatively, the thermal capacity parameter can be evaluated as a rate of change of the temperature of the working fluid relative to the heat applied and/or the rate of change of the temperature of the cooking cavity. The slope of the working fluid temperature as a function of time (e.g., slope of the temperature curve) can be evaluated continuously, over an interval (e.g., static, dynamic), and/or otherwise evaluated, and can additionally employ any suitable filtering or smoothing techniques. This lookup table can be generated empirically (e.g., by fitting a set of piecewise polynomials to test data) and/or analytically to achieve a reasonable degree of accuracy. This determination can neglect variables such as ambient temperature, heating power variance, and/or appliance wall (interior) temperature to reduce computational complexity, but can alternatively include them. Likewise, the volume of the working fluid can be calculated using other suitable techniques such as Kalman filtering (e.g., as described in U.S. application Ser. No. 17/100,046, filed 20 Nov. 2020, which is incorporated herein in its entirety by this reference) and/or any other suitable models.

Accordingly, in the first and second variants the thermal capacity parameter is preferably proportional to the volume of the working fluid (and/or volume of the working fluid in combination with the thermal properties of the vessel and/or foodstuff), but can additionally or alternatively be dissociated from the volume of the working fluid and/or exclude any direct calculation of the working fluid.

In an example, a conventional bring-up time required to achieve an equilibrium temperature within 5 degrees C. of the target temperature can be about 10 minutes. The slope of the working fluid curve during the first 2 minutes of this curve can be approximately linear, and can be used to select an appropriate thermal model in S120 well in advance of the eventual equilibrium temperature nearing the target temperature. In this example, an initial determination of the working fluid volume can be made after the first 2 minutes of preheating with minimal likelihood of overshoot (during the first 2 minutes), and the working fluid volume determination may be subsequently updated during any suitable portion of bring-up, pre-heating, and/or sous vide cooking.

However, the thermal capacity parameter fluid volume can be otherwise suitably determined and/or not explicitly determined (e.g., specified as a dimensionless variable or index for S120; implicitly determined as a hidden variable of a neural network; etc.).

However, the thermal model can be otherwise suitably determined.

Determining an equilibrium temperature based on the thermal model S130 functions to predict the maximal/equilibrated temperature which working fluid, food, cooking cavity, and/or thermal system (e.g., including the cooking cavity, working fluid, vessel, and/or food) will reach in absence of additional appliance heating. The thermal model can be used to estimate the thermal equilibrium temperature: continuously, periodically, in response to receipt of temperature measurements, concurrently with control of the cooking appliance during S140 (e.g., during S142, etc.), and/or with any other suitable timing. S130 is preferably performed locally (e.g., at a local processing system onboard the cooking appliance, at a user device, etc.), but can be performed at any other suitable processing endpoints. The equilibrium temperature can be calculated using individual measured values of the cooking cavity temperature and the working fluid temperature, however the equilibrium temperature can be computed using a rolling-averages, filtered measurements (e.g., filtered for outliers, filtered for noise, filtered using a Bayesian filter, such as a Kalman filter, etc.), and/or other suitable temperature curves with any suitable smoothing and/or filtering. However, some variants (e.g., such as those employing pre-trained neural networks, which can be appliance specific) may inherently filter noise and/or variance associated with sensor noise and oven leakage, since the evaluation is based on longer time history (e.g., entire temperature profile or time-history for a cook session), but may additionally be adjusted to account for other forms of measurement errors (e.g., measurement calibration offset, etc.).

However, the equilibrium temperature can be otherwise suitably determined.

Facilitating control of a cooking appliance based on the equilibrium temperature S140 functions to enable cooking of foodstuff within the working fluid (e.g., by a sous vide cooking process) substantially at the target temperature (e.g., deviations within the temperature thresholds). In variants, S140 can include: bringing-up a thermal energy of the cooking appliance S142; and maintaining the working fluid temperature S144. Additionally or alternatively, S140 can function to: pre-heat and/or ‘bring up’ the thermal system (e.g., which includes the working fluid; a thermal system which includes of the cooking cavity, air within the cooking cavity, fluid vessel, and working fluid; etc.) to achieve the target temperature. S140 can also function to equilibrate the thermal system of the appliance, maintain the equilibrium temperature substantially at the target temperature (e.g., within a threshold range of the target temperature), and/or perform other functions.

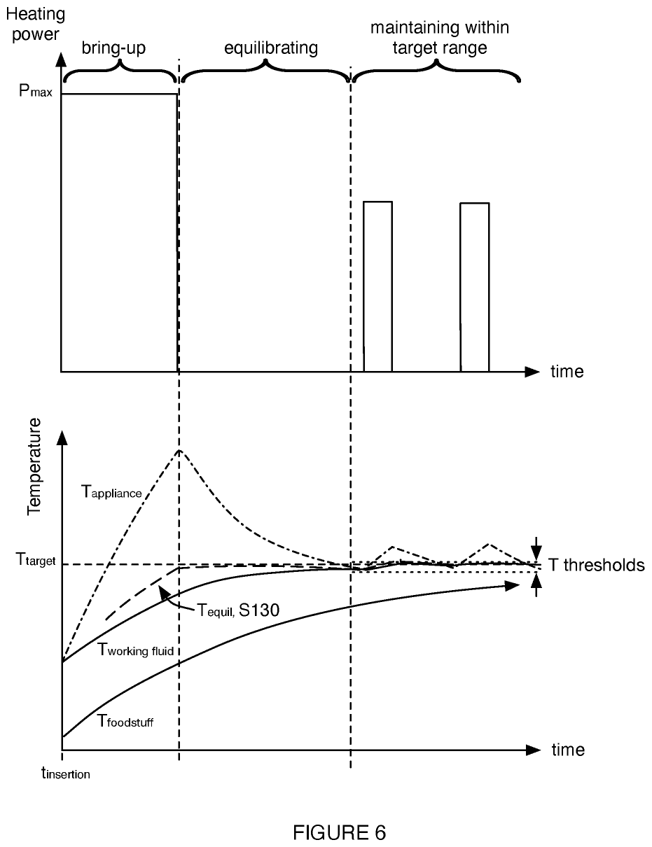

S140 can include ‘bringing-up’ the thermal energy of the appliance S142 to achieve the target temperature of the working fluid. Preferably, bring-up includes operating the heating elements uniformly and/or at a maximum power (e.g., an example is shown in FIG. 6), which can be beneficial for determining the thermal capacity parameter for the working fluid S122 and/or minimizing the bring-up time (and/or time required to reach thermal equilibrium). However, the heating elements can be operated at a predetermined proportion of the maximum output (e.g., based on the temperature difference between the equilibrium temperature and the target temperature, etc.) and/or otherwise suitably operated.

Bring-up can continue until and/or terminates upon satisfaction of a target condition. The target condition is preferably based on the target temperature, but can additionally or alternatively be based on an overshoot threshold (e.g., maximum historical overshoot, historical variance in equilibration for the cooking appliance, etc.) and/or a predetermined offset from the target temperature, one or more cooking parameters, and/or any other suitable parameters. As an example, the target condition can be satisfied when the equilibrium temperature of the appliance, working fluid, and/or food is substantially equal to the target temperature and/or within a predetermined range of the target temperature (e.g., within 5%, within a range of measurement variance, within 2° F., etc.); however, bring-up can additionally or alternatively terminate when the bring-up temperature is within a threshold range of the target temperature. For instance, the threshold range of the target temperature can extend below the target temperature, and/or can be a range encompassing the target temperature (e.g., above and below the target temperature; symmetric about the target temperature; asymmetric about the target temperature), and/or otherwise related to the target temperature. The threshold range can be a predetermined number of degrees from the target temperature (e.g., 1° F., 3° F., 10° F., a number therebetween, etc.), a predetermined proportion of the target temperature (e.g., 1%, 10%, etc.), and/or otherwise defined. Accordingly, the equilibrium temperature of appliance is preferably calculated periodically and/or continuously during bring-up and/or S122, S120, and/or S130 can be performed repeatedly during bring-up.

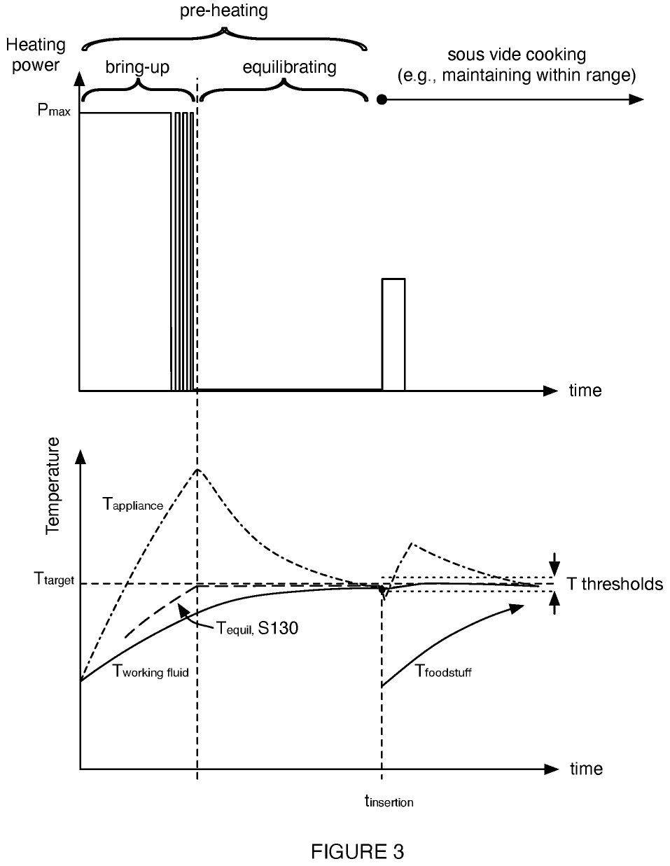

During S142, the temperature of the cooking cavity and/or the working fluid temperature can monotonically increase and/or strictly increase (e.g., slope of temperature-time curve strictly greater than zero). In variants, this can result in a maximal value of the cooking cavity temperature at the termination of bring-up. In some variants, the observability of the cooking cavity temperature (e.g., by the appliance temperature sensor) may be temporally dependent, since continuous heating can result in a temperature difference between the heating elements, the remainder of the cooking cavity, and the temperature sensor. In some examples, it can be beneficial to power cycle the heating elements (e.g., cycling the power on and off) as the calculated equilibrium temperature approaches the target temperature (e.g., examples are shown in FIG. 2 and FIG. 3), such as when the temperature is within a power-cycling threshold deviation from the target temperature (e.g., same or different from the threshold bounding deviations of the temperature of the working fluid; temperature rise of the working fluid is 90% of the difference between an initial working fluid temperature and the target temperature; within 5 degrees of the target temperature; etc.). In such examples, the temperature measurements can be sampled after a predetermined delay, after the slope of the temperature curve is less than predetermined threshold (e.g., 10%) of the slope during heating (e.g., for a period immediately preceding power-cycling), and/or otherwise suitably account for the temporal offset of heating, such as by applying a predetermined offset to temperature measurements, incorporate sensor observability into the thermal model, ramp down heating, apply various feedback/feedforward observability controls (e.g., Kalman filtering, etc.). The power cycling pattern is preferably selected based on the working fluid volume, but can additionally or alternatively be selected based on: the working fluid temperature, the cavity temperature, user inputs, cooking parameters, and/or any other suitable parameter(s). However, temporal observability of cooking cavity temperature can otherwise be neglected. However, heat elements can be otherwise suitably controlled to bring up the temperature of the working fluid.

In variants, S140 can optionally include a period of thermal equilibration (e.g., after bring-up), during which the working fluid increases in temperature to achieve an equilibrium condition substantially at the target temperature (e.g., and/or an allowable deviation therefrom—such as within 1-2 degrees Fahrenheit; with the appliance decreasing in temperature; while the thermal system equilibrates). For example, heating in accordance with S142 may terminate when a target condition is satisfied (e.g., estimated equilibrium temperature within range of target foodstuff temperature), and dynamic (e.g., feedback) heating control during S144 may subsequently initiate in response to satisfaction of an equilibrium condition (e.g., temperature measurement at appliance temperature sensor is substantially equal to the temperature measurement at the vessel; temperature of appliance is within the target temperature range; temperature difference threshold satisfied; temporal threshold satisfied; etc.). The equilibration condition can be based on: the equilibrium temperature, a temperature difference threshold, a slope comparison, a temporal threshold, a temperature threshold, and/or any other suitable parameters. While the thermal system equilibrates (e.g., between S142 and S144) and/or during S144, the equilibrium temperature may be repeatedly estimated in accordance with Block S130 (e.g., to verify that a target condition remains satisfied) and/or the system may be substantially idle.

The heating elements are preferably unpowered while the appliance is equilibrating, but can additionally or alternatively be operated (e.g., continuously) at a low power and/or periodically (e.g., to balance thermal losses to the environment), and/or in response to an updated equilibrium temperature falling below a temperature threshold (e.g., if the door is opened, upon insertion of foodstuff to the working fluid; for models yielding conservatively low estimates of the equilibrium temperature at the termination of bring-up).

In an illustrative example, the thermal system can be considered equilibrated in many cases when a temperature exists between the fluid vessel, working fluid, and the walls of the cooking cavity (i.e., where the temperature measured at the appliance temperature sensor deviates from the temperature measured at the vessel temperature sensor), such as where the temperature difference is sufficiently small (e.g., within a few degrees F.) so as to enable working fluid feedback control with minimal risk of overshoot. Further, this may dramatically reduce pre-heating time (e.g., bring-up+equilibration period) and the net cooking-session time for sous vide cooking within the fluid vessel.

However, the thermal system of the cooking appliance, fluid vessel, and working fluid can be otherwise equilibrated. For instance, after the target condition is satisfied, S140 may alternatively transition to feedback control based on the equilibrium temperature (e.g., which may necessarily result similar effect of facilitating equilibration with the heating elements idle).

S140 can include maintaining a working fluid temperature S144, which functions to maintain the working fluid temperature (and/or equilibrium temperature) substantially at the target temperature to facilitate sous vide cooking of foodstuff therein. S144 preferably includes dynamically controlling the set of heating elements 106 to maintain a working fluid temperature within a threshold deviation from the target temperature (e.g., to substantially maintain the equilibrium condition). During S144, heating elements can be controlled by a feedforward control scheme (e.g., based on an equilibrium temperature estimation using the thermal model), a feedback control scheme (based on the temperature of the working fluid and/or measured temperature from the vessel temperature sensor 130; PID control, etc.), and/or any other suitable control scheme(s). In some cases, (working fluid and/or vessel) feedback control approaches may be less prone to overshoot issues once the thermal system has equilibrated (e.g., after pre-heating), since the thermal mass of the system is large relative to the thermal leakage (e.g., which is being offset by powering heating elements during S144). When heating elements are powered, they can be controlled at a constant/fixed power level (e.g., 50% power, about 40-60% of maximum power, etc.), a variable/dynamic power level, and/or can be otherwise suitably controlled. Heating elements are preferably operated in response to determining of a deviation of the equilibrium temperature from the target temperature (e.g., based on a recurrent determination according to S130), but can additionally or alternatively be controlled based on a change in the measured temperature at the vessel temperature sensor, a change in the measured cavity temperature, and/or at any other suitable time.

In a first example, the heating elements can be powered when the equilibrium temperature drops below a threshold deviation from the target temperature (e.g., 1 degree below the target temperature, 0.5 degrees below the target temperature, etc.; in Fahrenheit or Celsius). In a second example, the heating elements can be powered proportional to the deviation of the equilibrium temperature from the target temperature. In a third example, the heating elements can be unpowered (and/or controlled at low power to balance environmental heat loss) when the equilibrium temperature is within a threshold deviation of the target temperature, thereby allowing thermal equilibration of the cooking cavity and the working fluid. In a fourth example, the heating elements are power cycled (e.g., as discussed above for bring-up) until the equilibrium temperature and/or measured working fluid temperature meets the target temperature. In a sixth example, the heating elements are powered based on a temperature difference between the sampled vessel temperature and the target temperature (e.g., such as the sampled temperature falling below a threshold).

During bring-up S142, the temperature curve (function of temperature versus time) of the working fluid temperature is preferably strictly increasing (with slope greater than zero), but can additionally or alternatively be monotonically increase, and/or can be smoothed into an increasing function, but can additionally or alternatively have any other suitable shape. Accordingly, the term “pre-heating” as utilized herein may refer to the period of bring-up and/or the subsequent period of equilibration (e.g., while the net thermal energy of the cooking appliance decreases, but the working fluid continues to increase in temperature); however, this term may be otherwise suitably referenced and/or have any other suitable meaning. During S140, the temperature of the cooking cavity (e.g., and/or temperature measured at the cooking appliance) is preferably strictly increasing during S142 and preferably strictly decreasing while the thermal system equilibrates, with a global maximum temperature of the cavity (during the cooking process) occurring therebetween. However, the temperature curve of the working fluid can additionally or alternatively include periods of increasing temperature after bring-up (e.g., for dynamic adjustments, such as: to adjust for a cooking appliance door opening, to balance heat loss to the environment, when foodstuff added after bring-up, etc.). Accordingly, the working fluid temperature curve can include local maximum temperatures (e.g., less than the maximum temperature at the end of bring-up) associated with dynamic adjustments of the equilibrium temperature, which can exceed the target temperature of the working fluid (e.g., and/or the maximal threshold/upper-bound of the allowable temperature deviation of the working fluid). However, the temperature curves can include any other suitable characteristics.

Foodstuff can be arranged within the working fluid during any suitable portions of S140. In a first variant, the foodstuff can be inserted in advance of and/or during pre-heating/bring-up (an example is shown in FIG. 6). In a second variant, the foodstuff can be inserted after pre-heating and/or equilibration of the working fluid and cooking cavity temperatures (e.g., an example is shown in FIG. 3). In both the first and second variants, the foodstuff is preferably arranged within the working fluid while the working fluid is maintained within the threshold of the target temperature, as part of a sous vide cooking process (e.g., with the foodstuff arranged within a vacuum sealed bag, etc.), at least until the internal temperature of the foodstuff substantially reaches the target temperature. In variants, the temperature can be maintained for 30 minutes, 1 hour, 2 hours, 4 hours, more than 4 hours, and/or any suitable range bounded by the aforementioned values. In a specific example, the temperature can be maintained according to a sous vide cook time (e.g., as a specified cooking parameter received in S110). However, the temperature can additionally or alternatively be maintained until a cooking completion condition is satisfied—such as a meat thermometer measurement which satisfies a completion condition, user input, optical determination that the foodstuff/vessel has been removed, and/or any other suitable completion condition. However, foodstuff can be otherwise cooked by a sous vide process within the working fluid.

During S140, air within the cooking cavity can be stagnant and/or convectively circulated (e.g., forced convection, natural convection, etc.). In variants, the air can be circulated continuously and/or periodically during S140 by a set of convection elements within the appliance. In variants where the air remains within the cooking cavity during a portion of cooking, the air can act as an insulative barrier around the working fluid and/or foodstuff, thereby decreasing temperature fluctuation. Accordingly, this can eliminate the need for the working fluid to be circulated within the vessel and/or about the foodstuff. However, the working fluid can additionally or alternatively be circulated by convection elements (e.g., submerged, mounted to the vessel, etc.), and/or can circulate by natural convection.

However, the working fluid temperature can be otherwise suitably maintained.

Cavity heating can additionally or alternatively be ceased when a cessation condition is met. Examples of cessation conditions include: timer expiration (e.g., the food or working fluid is held at the target temperature for a threshold period of time), user instruction, and/or any other condition.

Alternative embodiments implement the above methods and/or processing modules in non-transitory computer-readable media, storing computer-readable instructions. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

We claim:

1. A method for sous vide cooking within a cooking cavity of a cooking appliance, comprising:
determining a target foodstuff temperature;
heating a thermal system comprising the cooking cavity, a working fluid, and a vessel within the cooking cavity which contains the working fluid, comprising:
controlling a set of heating elements to heat the cooking cavity;
receiving a series of temperature measurements from a first temperature sensor thermally coupled to the working fluid;
based on the series of temperature measurements and using a thermal model for the thermal system, estimating an equilibrium temperature of the thermal system based on a first measurement from the first temperature sensor and an cooking appliance temperature; and
in response to the equilibrium temperature satisfying a target condition based on the target foodstuff temperature, ceasing heating with the set of heating elements; and
subsequently, when an equilibration condition is satisfied, controlling the heating elements to substantially maintain the working fluid at the target foodstuff temperature using temperature feedback from the first temperature sensor.

2. The method of claim 1, further comprising: while heating the thermal system prior to satisfaction of the target condition, determining the thermal model based on the series of temperature measurements.

3. The method of claim 2, wherein determining the thermal model comprises estimating a thermal capacity parameter of the thermal system based on a rate of change of the series of temperature measurements.

4. The method of claim 2, wherein the thermal model is determined using a trained neural network.

5. The method of claim 2, further comprising: updating the thermal model based on an estimated thermal leakage from the cooking appliance.

6. The method of claim 1, wherein the equilibration condition is based on a temperature difference between the first temperature sensor and the cooking appliance temperature.

7. The method of claim 1, wherein the equilibration condition is a time-based condition.

8. The method of claim 1, wherein the set of heating elements are operated at a greater power prior to satisfaction of the target condition than after satisfaction of equilibration condition.

9. The method of claim 1, wherein the set of heating elements are operated at uniform power across a period of the series of temperature measurements.

10. The method of claim 1, target condition comprises a temperature which is offset below the target foodstuff temperature based on an overshoot threshold.

11. The method of claim 1, further comprising: actively circulating air internally within the cooking cavity.

12. The method of claim 1, wherein the temperature of working fluid monotonically increases between satisfaction of the target condition and satisfaction of the equilibration condition, wherein the cooking appliance temperature monotonically decreases between satisfaction of the target condition and satisfaction of the equilibration condition.

13. The method of claim 1, wherein the thermal model comprises a neural network model.

14. A system for sous vide cooking, comprising:
a cooking appliance, comprising: a cooking cavity, a set of heating elements within the cooking cavity, and a cooking cavity temperature sensor thermally coupled to the cooking cavity and fluidly coupled to interior air within the cooking cavity;
a vessel configured to contain a working fluid and arrangeable within the cooking cavity, wherein the vessel is surrounded by the interior air when within the cooking cavity;
a temperature probe thermally coupled to the working fluid;
a processing system communicatively coupled to the temperature probe, the appliance temperature sensor, and the set of heating elements; and
a non-transitory computer readable medium having stored thereon software instructions that, when executed by the processing system, cause the processing system to pre-heat the cooking appliance for sous vide cooking at a target temperature by:
controlling the set of heating elements to heat the cooking cavity;
determining a thermal model based on a series of temperature measurements received from the temperature probe;
based on a first temperature received from the temperature probe and a second temperature received from the appliance temperature sensor, estimating an equilibrium temperature for the vessel using the thermal model; and
in response to the equilibrium temperature satisfying a target condition based on the target food temperature, ceasing heating with the set of heating elements; wherein the first temperature is below the target temperature when heating is ceased.

15. The system of claim 14, wherein the target condition comprises a temperature range which is asymmetric about the target food temperature.

16. The system of claim 14, wherein after pre-heating the thermal system, the instructions executed by the processing system further cause the processing system further to: determine that working fluid has reached the target temperature using the temperature probe; and, subsequently, control the set of heating elements to maintain the working fluid at the target foodstuff temperature using temperature feedback from the temperature probe.

17. The system of claim 14, wherein the temperature probe is thermally coupled to the working fluid through a thickness of a vessel wall.

18. The system of claim 14, wherein the vessel is surrounded by the interior air on at least two sides when arranged within the cooking cavity.

19. The system of claim 18, wherein the vessel is removably arranged on a rack of the cooking appliance.

20. The system of claim 14, wherein the processing system is further configured to repeat the pre-heating of the cooking appliance in response to the first temperature falling below a temperature threshold.
